(19) United States
(12) Patent Application Publication
(10) Pub. No.: US 2026/0307714 A1
(43) Pub. Date: Oct. 8, 2026

(54) Vehicle steering system

(71) Applicant: Dongguan Hobby Plus RC Technology Co., Ltd., Dongguan (CN)

(72) Inventors: Juan Wu, Dongguan (CN); Ruiyuan Zhou, Dongguan (CN)

(73) Assignee: Dongguan Hobby Plus RC Technology Co., Ltd., Dongguan (CN)

(21) Appl. No.: 19/298,701

(22) Filed: Aug. 13, 2025

(30) Foreign Application Priority Data
Apr. 8, 2025 (CN) 2025206525882

(51) Int. Cl. B62D 6/00; B62D 5/04

(52) U.S. Cl. CPC B62D 6/002; B62D 5/0442; B62D 6/001

(57) ABSTRACT

A vehicle steering system includes a vehicle body, a control unit, a receiver unit, a front steering servo motor, and a rear steering servo motor; the control unit is either internally mounted within or externally attached to the vehicle body and configured to send the front and rear wheel steering signal to the receiver unit; the front steering servo motor is connected to the front wheel and controls the steering angle thereof; the rear steering servo motor is connected to the rear wheel and controls the steering angle thereof; when the receiver unit is received the front and rear wheel steering signals, the front wheel steering signal is used for adjusting the steering angle of the front wheel via the front steering servo motor, the rear wheel steering signal is used for adjusting the steering angle of the rear wheel via the rear steering servo motor.

### FIELD OF THE INVENTION

The disclosure relates to the technical field of the vehicle, particularly, to a vehicle steering system.

### BACKGROUND OF THE INVENTION

As shown in FIG. 1, the conventional vehicle control system is restricted to sequential cycling between Steering Modes 1 to 4. It fails to allow direct transitions from Steering Mode 1 to Steering Mode 3 or 4, nor from Steering Mode 2 to Steering Mode 4. Additionally, the reverse switching sequence cannot be achieved. This operational limitation causes inconvenience and adversely impacts user experience.

For both model vehicles and full-scale vehicles (production automobiles), their steering systems are generally required to sequentially cycle through predetermined modes without the capability of skipping modes or achieving immediate control. This limitation results in restricted steering flexibility.

### SUMMARY OF THE INVENTION

The object of the disclosure is to provide a vehicle steering system, aiming to solve the technical problems that the existing steering systems are generally required to sequentially cycle through predetermined modes without the capability of skipping modes or achieving immediate control, which limitation results in restricted steering flexibility.

To achieve the above object, the disclosure provides a vehicle steering system, which includes a vehicle body, a control unit, a receiver unit, a front steering servo motor, and a rear steering servo motor. The receiver unit is disposed on the vehicle body. The control unit is either internally mounted within or externally attached to the vehicle body and configured to send the front wheel steering signal and the rear wheel steering signal to the receiver unit according to user instructions. The front steering servo motor is connected to the front wheels and controls the steering angles thereof; the rear steering servo motor is connected to the rear wheels and controls the steering angles thereof; when the receiver unit receives the front wheel steering signals or the rear wheel steering signals, the front wheel steering signals are used for adjusting the steering angles of the front wheels via the front steering servo motor. The rear wheel steering signals are used for adjusting the steering angles of the rear wheels via the rear steering servo motor.

Optionally, the vehicle steering system also includes a control handle, the control unit is provided within the handle. The handle is equipped with a first control key and a second control key. The user transmits the front wheel steering signals to the control unit via the first control key and the rear wheel steering signals to the control unit via the second control key, with the first and second control keys operating independently.

Optionally, both the first control key and the second control key are designed as rotary knobs or operation disks.

Optionally, the vehicle body is equipped with a front wheel assembly and a rear wheel assembly. The front wheel assembly includes a front axle mounted on the vehicle body and one or several front wheels disposed at opposite ends of the front axle. The rear wheel assembly includes a rear axle mounted on the vehicle body and one or several rear wheels disposed at opposite ends of the rear axle. The front wheel assembly and the rear wheel assembly can be turned freely through a transmission shaft connection or without a transmission shaft connection. The front steering servo motor is installed on the front wheel assembly, while the rear steering servo motor is installed on the rear wheel assembly.

Optionally, both the front wheel assembly and the rear wheel assembly are provided in two sets, the transmission shaft for transmitting power can be installed between two adjacent sets of the front wheel assemblies and between two adjacent sets of the rear wheel assemblies. It is also possible to install the transmission shaft that does not transmit power.

Optionally, both the front wheel and the rear wheel include a wheel body and a mounting base. The mounting base is hinged to the front axle or the rear axle. The wheel body is mounted on the mounting base. A first connector is provided between two mounting bases hinged to the front axle and between two mounting bases hinged to the rear axle, with both ends of the first connector hinged to the two mounting bases.

Optionally, both the front wheel assembly and the rear wheel assembly are pivotally equipped with a second connector. The second connector is hinged to the mounting bases on the same side.

Optionally, both the front axle and the rear axle are internally penetrated by a rotating shaft. The rotating shaft engages with the transmission shaft via bevel gears for torque transmission. The rotating shaft is hinged to the front wheel or the rear wheel.

Optionally, inside both the front axle and the rear axle, a rotating shaft with power can be provided. For those without power, a rotating shaft can be omitted. It is also possible to achieve the front and rear steering with or without power for this function. The rotating shaft is meshed and driven with the transmission shaft through bevel gears, and the rotating shaft is hinged with the corresponding front wheel or the rear wheel.

Optionally, the vehicle is a remote-controlled model car, which includes a control handle separated from the vehicle body. The control unit is housed within the handle and transmits the front wheel steering signal and the rear wheel steering signal to the receiver unit via wireless communication.

Optionally, the steering of both the front and rear wheels is real-time full-scale proportional steering.

Compared to the prior art, one or more technical solutions in the vehicle steering system provided by the embodiments of the disclosure achieve at least the following technical effects: During operation, the user may transmit the instruction to the control unit via directional input devices, e.g., buttons, knobs, or control panels, etc, The control unit, upon receiving the signals, forwards the front wheel steering signals and/or the rear wheel steering signals to the receiver unit. After the receiver unit receives the front and/or rear wheel steering signals, the front wheel steering signal controls the front wheel steering angle via the front steering servo motor, and the rear wheel steering signal controls the rear wheel steering angle via the rear steering servo motor. The vehicle steering system provided in the embodiments of the disclosure enables independent steering of the front wheels and the rear wheels, with no correlation between the two. That is, the front wheels can steer at any angle within a certain range, and the rear wheels can also steer at any angle within a certain range unrestricted by the steering angle of the front wheels. The front and rear wheels are not restricted by the need of the existing model vehicle steering systems to cyclically switch between different modes in a predefined sequence. It can achieve instant control, with flexible steering and convenient operation.

### BRIEF DESCRIPTION OF THE DRAWINGS

To more clearly illustrate the technical solutions in the embodiments of the disclosure, the following briefly introduces the drawings required for describing the embodiments or the prior art. Obviously, the drawings in the following description show only some embodiments of the disclosure. For persons of ordinary skill in the art, other drawings may be derived from these drawings without creative efforts.

FIG. 1 is a schematic diagram showing mode transitions of a prior art model vehicle control system.

FIG. 2 is a schematic diagram illustrating the control flow of the vehicle steering system in the disclosure.

FIG. 3 is a schematic diagram showing the bottom structure of the vehicle in the disclosure.

FIG. 4 is a schematic structural diagram depicting the cooperative positioning between the rear axle and the rear steering servo motor in the disclosure.

### REFERENCE NUMERALS IN THE DRAWINGS

The front steering servo motor 10; the rear steering servo motor 20; the vehicle body 100; the front wheel assembly 110; the front wheel 111; the wheel body 1111; the rear wheel assembly 120; the rear wheel 121; the mounting base 1211; the rear axle 122; the transmission shaft 140; the first connector 150; the second connector 160; the rotating shaft 170; the control unit 200; the receiver unit 300.

### DETAILED DESCRIPTION OF ILLUSTRATED EMBODIMENTS

The embodiments of the present disclosure are described in detail below. Examples of the embodiments are illustrated in the accompanying drawings, wherein identical or similar reference numerals throughout denote identical or similar components or components having identical or equivalent functions. The embodiments described concerning the drawings are exemplary and intended to explain the present disclosure, but shall not be construed as limiting the disclosure.

In the description of the embodiments of the present disclosure, it is to be understood that terms indicating orientations or positional relationships—such as "length," "width," "upper," "lower," "front," "rear," "left," "right," "vertical," "horizontal," "top," "bottom," "inner," and "outer"—are based on orientations or positional relationships shown in the accompanying drawings. These terms are used solely to facilitate describing the embodiments and simplify the description, not to indicate or imply that the referenced apparatus or component must have a specific orientation or be constructed/operated in a specific orientation. Thus, such terms shall not be construed as limiting the disclosure.

Furthermore, the terms "first" and "second" are used for descriptive purposes only and shall not be interpreted as implying relative importance or implicitly specifying the quantity of technical features. Features defined by "first" or "second" may explicitly or implicitly include one or more such features. In the description of the embodiments, "plurality" means two or more unless expressly defined otherwise.

In the embodiments of the present disclosure, unless explicitly defined or limited, terms such as "mounted," "connected," "linked," and "fixed" shall be interpreted broadly. For example, a connection may be permanent (e.g., welded) or detachable (e.g., bolted); A connection may be mechanical (e.g., gear-coupled) or electrical (e.g., wire-bonded); Components may be directly connected or indirectly connected via an intermediary; The term may refer to internal communication between two components or their interactive relationship. Persons of ordinary skill in the art may interpret these terms in the context of the specific implementation.

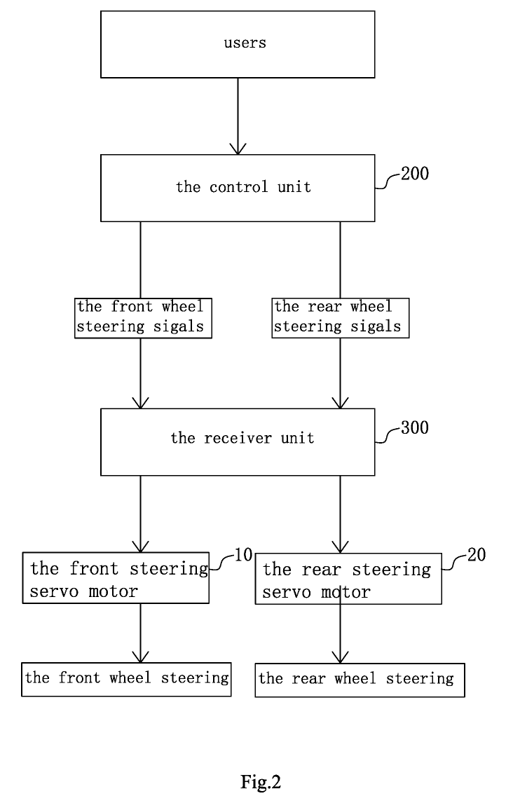

As shown in FIGS. 2-4, an embodiment of the disclosure provides a vehicle steering system, which includes a vehicle body 100, a control unit 200, a receiver unit 300, a front steering servo motor 10, and a rear steering servo motor 20.

The control unit 200 is either internally integrated within or externally attached to the vehicle body 100. The receiver unit 300 is disposed on the vehicle body 100. The control unit 200 is configured to send the front wheel steering signals and the rear wheel steering signals to the receiver unit 300 according to the user instructions. The front steering servo motor 10 is connected to the front wheels 111 and controls the steering angles thereof, while the rear steering servo motor 130 is connected to the rear wheels 121 and controls the steering angles thereof. The receiver unit 300 receives the front wheel steering signals and the rear wheel steering signals, the front wheel steering signals adjust the steering angles of the front wheels 111 via the front steering servo motor 10, and the rear wheel steering signals adjust the steering angles of the rear wheels 121 via the rear steering servo motor 20.

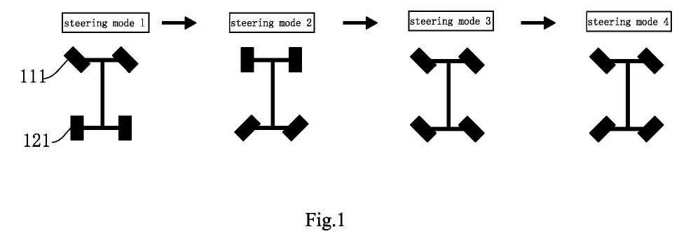

It is to be understood that the prior art model vehicle steering control system, as illustrated in FIG. 1, is limited to four predefined steering modes:
(1) Front wheels 111 deflected left with rear wheels 121 maintaining a straight alignment;
(2) Front wheels 111 maintaining a straight alignment with rear wheels 121 deflected right;
(3) Simultaneous leftward deflection of both front and rear wheels 111 and 121;
(4) Front wheels 111 deflected left with rear wheels 121 deflected right.

Users are required to cyclically toggle through these four modes until the desired mode is activated, resulting in significant operational inconvenience.

In the vehicle steering system provided by the embodiment of the disclosure, independent steering of the front wheels 111 and rear wheels 121 is achieved, wherein their operations are decoupled. Specifically, the front wheels 111 can be steered to any angle within a predefined range, while the rear wheels 121 are capable of unrestricted angular adjustment independent of the front wheels' position. This eliminates the prior art constraint of mandatory sequential cycling through fixed modes to the front wheels 111 and the rear wheels 121, enabling instantaneous control, enhanced steering flexibility, and user-friendly operation.

More specifically, as shown in FIG. 2, during operation, the user may transmit steering signals to the control unit 200 via directional control devices such as buttons, knobs, or control panels. Upon receiving the steering signals, the control unit 200 encodes the analog rotational inputs through a micro controller-based encoding program and outputs the encoded signals to the receiver unit 300. The receiver unit 300 decodes the encoded signals of the front and/or rear wheel steering and subsequently controls the steering angles of the front wheels 111 via the front steering servo motor 10 and the steering angles of the rear wheels 121 via the rear steering servo motor 20. It is noted that the user may transmit either the front wheel steering signal alone, the rear wheel steering signal alone, or both signals concurrently.

In some embodiments of the disclosure, a control handle (not illustrated) is further included. The control unit 200 is provided within the handle. The handle is equipped with a first control key and a second control key. The user transmits the front wheel steering signals to the control unit 200 via the first control key and the rear wheel steering signals to the control unit 200 via the second control key, with the first and second control keys operating independently. Specifically, in certain embodiments, both the first and second control keys are designed as rotary knobs, operation plates, or joysticks. By rotating the first and second control keys to distinct angular, the user achieves real-time transmission of angular signals.

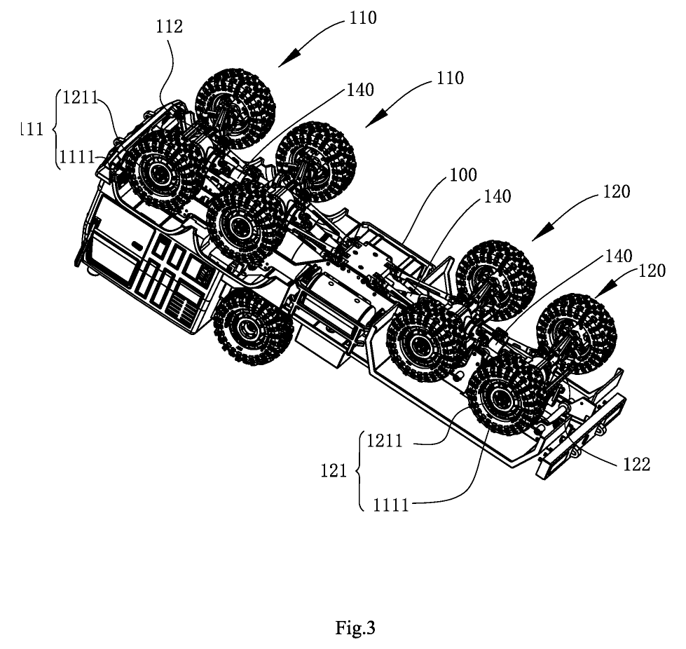

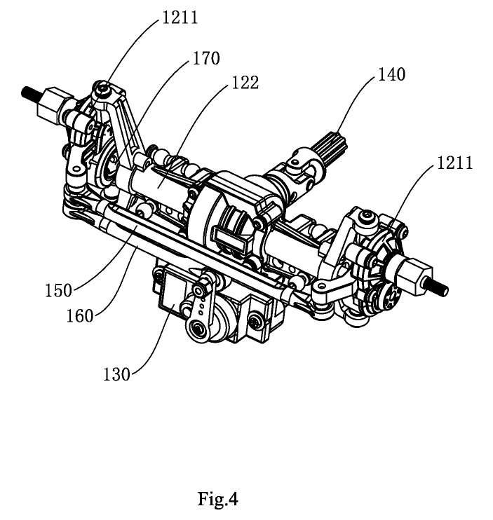

As shown in FIGS. 3 and 4, in some embodiments of the disclosure, the vehicle body 100 is equipped with a front wheel assembly 110 and a rear wheel assembly 120. The front wheel assembly 110 includes a front axle 112 mounted on the vehicle body 100 and two front wheels 111 disposed at opposite ends of the front axle 112. The rear wheel assembly 120 includes a rear axle 122 mounted on the vehicle body 100 and two rear wheels 121 disposed at opposite ends of the rear axle 122. The front wheel assembly 110 and the rear wheel assembly 120 are in transmission connection via the transmission shaft 140. A transmission shaft 140 is required when the transmission is needed and can be omitted when there is no need for transmission. The front steering servo motor 10 is installed on the front wheel assembly 110, while the rear steering servo motor 20 is installed on the rear wheel assembly 120. Specifically, the steering mode can be used for front-wheel drive, rear-wheel drive, or all-wheel drive transmission.

As shown in FIG. 3, in some embodiments, both the front wheel assembly 110 and the rear wheel assembly 120 are provided in two sets. Certainly, in some other embodiments, it is also feasible to provide one set or more sets of the front wheel assemblies 110 and the rear wheel assemblies 120 respectively. When multiple sets of front wheel assemblies 110 and rear wheel assemblies 120 are installed, multiple sets of corresponding front steering servo motors 10 and rear steering servo motors 20 should also be installed accordingly. The more sets of steering servo motors are added, the more front wheel assemblies 110 and rear wheel assemblies 120 should be added correspondingly.

In some embodiments, both the front wheel 111 and the rear wheel 121 include a wheel body 1111 and a mounting base 1211. The mounting base 1211 of the front wheel 111 is hinged to the front axle 112, while the mounting base 1211 of the rear wheel 121 is hinged to the rear axle122. As shown in FIG. 4, taking the rear wheel assembly 120 as an example, the mounting base 1211 is rotatable about a vertical axis relative to the rear axle 122. The wheel body 1111 is mounted on the mounting base 1211. A first connector 150 is provided between the two mounting bases 1211 hinged to the rear axle 122, and both ends of the first connector 150 are hinged to the respective mounting bases 1211. When the rear steering servo motor 20 controls one of the mounting bases 1211 to rotate, and both mounting bases 1211 are driven by the first connector 150 to synchronously rotate, thereby achieving coordinated steering of the rear wheels 121. The steering structure and methodology for the front wheel assembly 110 are identical to the rear wheel assembly 120 and thus not reiterated herein.

As shown in FIG. 4, in some embodiments, both the front wheel assembly 110 and the rear wheel assembly 120 are pivotally equipped with a second connector 160. The second connector 160 is hinged with the same sides of the mounting bases 1211. Taking the rear wheel assembly 120 as an example, when the rear steering servo motor 20 rotates through a specified angle, it drives the second connector 160 to rotate, thereby pushing or pulling the mounting bases 1211 to rotate and achieving steering of the rear wheels 121. The steering principle for the front steering servo motor 10 is identical to the rear steering servo motor 20 and thus not reiterated herein.

Both the front axle and rear axle are internally penetrated by a rotating shaft 170. The rotating shaft 170 engages with the transmission shaft 140 via bevel gears for torque transmission. The rotating shaft 170 is hinged to the front wheel 111 or the rear wheel 121.

In some embodiments, the vehicle is a remote-control model car, which comprises a control handle, separated from the vehicle body 100. The control unit 200 is housed within the handle and transmits front and rear wheel steering signals to the receiver unit 300 via wireless communication, thereby achieving remote control of the vehicle.

In some embodiments, the steering of both the front wheels and the rear wheels is real-time full-scale proportional steering.

It should be noted that the vehicle system in this disclosure is applicable to non-independent suspension vehicle models with transmission, non-independent suspension vehicle models without transmission, independent suspension vehicle models without transmission, and independent suspension vehicle models with transmission.

The above content is a further detailed description of the disclosure in combination with specific preferred embodiments. It cannot be determined that the specific implementation of the disclosure is only limited to these descriptions. For those ordinary technicians in the technical field to which the disclosure belongs, without departing from the concept of the disclosure, its structural form can be flexibly changed, and a series of derivative products can be developed. As long as several simple deductions or replacements are made, they should all be regarded as falling within the scope of patent protection determined by the claims submitted for the disclosure.

What is claimed is:

1. A vehicle steering system, comprising:
(a) a vehicle body;
(b) a receiver unit, disposed on said vehicle body;
(c) a control unit, either internally mounted within or externally attached to said vehicle body, configured to send a front wheel steering signal and a rear wheel steering signal to said receiver unit according to an instruction from a user;
(d) a front steering servo motor, connected to a front wheel and controlling a steering angle thereof;
(e) a rear steering servo motor, connected to a rear wheel and controlling a steering angle thereof;
said receiver unit is received said front rear wheel steering signal or said rear wheel steering signal, said front rear wheel steering signal is used for adjusting said steering angle of said front wheel via said front steering servo motor, and said rear wheel steering signal is used for adjusting said steering angle of said rear wheel via said rear steering servo motor.

2. The vehicle steering system according to claim 1, further comprising a control handle, said control unit is provided within said control handle; said control handle is equipped with a first control key and a second control key; said user transmits said instruction for said front wheel to said control unit via said first control key and said user transmits said instruction for said rear wheel to said control unit via said second control key, with said first control key and said second control key operating independently.

3. The vehicle steering system according to claim 2, wherein both said first control key and said second control key are rotary knobs.

4. The vehicle steering system according to claim 1, wherein said vehicle body is equipped with a front wheel assembly and a rear wheel assembly; said front wheel assembly includes a front axle mounted on said vehicle body and two front wheels disposed at opposite ends of said front axle; said rear wheel assembly comprises a rear axle mounted on said vehicle body and two rear wheels disposed at opposite ends of said rear axle; said front wheel assembly and said rear wheel assembly are mechanically coupled via a transmission shaft; said front steering servo motor is installed on said front wheel assembly, while said rear steering servo motor is installed on said rear wheel assembly.

5. The vehicle steering system according to claim 4, wherein both said front wheel assembly and said rear wheel assembly are provided in two sets; said transmission shaft for power transmission is disposed between adjacent sets of said front wheel assemblies and between adjacent sets of said rear wheel assemblies.

6. The vehicle steering system according to claim 4, wherein both said front wheel and said rear wheel include a wheel body and a mounting base; said mounting base is hinged to said front axle or said rear axle; said wheel body is mounted on said mounting base; a first connector is provided between said two mounting bases hinged to said front axle and between said two mounting bases hinged to said rear axle, with both ends of said first connector hinged to said mounting base.

7. The vehicle steering system according to claim 6, wherein both said front wheel assembly and said rear wheel assembly are pivotally equipped with a second connector; said second connector is hinged with the same sides of said mounting bases.

8. The vehicle steering system according to claim 7, wherein both said front axle and said rear axle are internally penetrated by a rotating shaft; said rotating shaft engages with said transmission shaft via bevel gears for torque transmission; said rotating shaft is hinged to said front wheel or said rear wheel.

9. The vehicle steering system according to claim 1, wherein the vehicle is a remote-control model car; said remote-control model car further comprises a control handle separated from said vehicle body; said control unit is housed within said handle and transmits said front wheel steering signal and said rear wheel steering signal to said receiver unit via wireless communication.

10. The vehicle steering system according to claim 1, wherein a steering of both said front wheel and said rear wheel is real-time full proportional steering.
